(19) United States
(12) Patent Application Publication
(10) Pub. No.: US 2026/0348166 A1
(43) Pub. Date: Nov. 5, 2026

(54) CARRIAGES AND SYSTEMS FOR ASSISTING WITH STAIRCASE NAVIGATION

(71) Applicant: LES SYSTÈMES SKYWALK INC., Montreal (CA)

(72) Inventors: David BARABÉ, Montreal (CA); Sébastien LAJOIE, Montreal (CA)

(21) Appl. No.: 19/125,525

(22) PCT Filed: Nov. 7, 2023
(86) PCT No.: PCT/CA2023/051483

§ 371 Date: Apr. 29, 2025

Related U.S. Application Data
(60) Provisional application No. 63/382,628, filed on Nov. 7, 2022.

(51) Int. Cl. E04F 11/18; A61H 3/00

(52) U.S. Cl. CPC E04F 11/1863; A61H 3/00; A61H 2003/001; A61H 2003/007

(57) ABSTRACT

A guide rail holds a carriage. The carriage provides a safety guard securable around a user and following the user during staircase navigation. the carriage includes a braking mechanism which, upon loss of balance of the user, engages a friction surface of a guiderail. Optionally, an engagement arm and friction cams, upon movement of the engagement arm disengage the friction surface of the guide rail. A texture cooperates with protrusions on the guide rail for increased friction. A secondary immobilization mechanism with a blocker engages the guide rail. Guard bars lift when the carriage is positioned at the top or bottom of the staircase. A counterweight balances the carriage within the guard rail.

### TECHNICAL FIELD

The present invention relates to a system for assisting a user with reduced mobility and, more specifically, for assisting a user with reduced mobility to navigate a staircase.

### BACKGROUND

People with reduced mobility, for example senior citizens or people recovering from injuries, often encounter issues when they live in multi-storey homes. Climbing or descending staircases can pose many dangers to them as they risk falling and injuring themselves. In addition, due to their reduced mobility, they may simply be incapable of navigating the stairs on their own. While many senior citizens leave their homes and move into seniors' residences at a certain point, these residences are often quite expensive. Further, many senior citizens are opposed to moving into a seniors' residence because they want to maintain their independence.

Currently, there exist multiple systems to assist people with reduced mobility to climb or descend staircases. For example, stair lifts are commonly used to carry people with reduced mobility up and down stairs. While these systems reduce the risk of falling, they are often quite expensive. In addition, many staircases are not compatible for stair lift installations, for example because they are too narrow or follow an abnormal path. Finally, while systems such as stair lifts provide a safe way for people with reduced mobility to navigate staircases, they do not offer the typical cardiovascular benefits that are associated with manually climbing and descending stairs with one's legs.

As such, there exists a need for a system that allows people with reduced mobility to more safely navigate stairs while reducing the risk of falling and promoting better cardiovascular health.

Known in the art, there is Canadian Patent No. 3076408C (LAJOIE) that discloses a suspension system for assisting a user to navigate a staircase. The suspension system includes a harness that is operatively connectable to a carriage that is displaceable on a beam located above the user. Although such known system may work well, there is a need in the market for alternative systems.

Another known system as described for example in European Patent EP3004485B1 (MEDBO) uses a double set of rails on the wall to support a set of bars that the user needs to lift and push up the stairs or lift and push down the stairs to ascend or descend the stairs. The geometry of the bar's attachment to the rails is what allows it to block. However, this known system cannot be adapted to secure the user if, for instance, they lose conscience or fall back without having the grip's strength to hold on to the bar.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a first aspect, the technique described herein relates to a carriage braking system. The carriage braking system may include an engagement arm and one or more engageably-disengageable friction cams. The engagement arm may be operatively linked to a carriage engaged to a guide rail having at least one friction surface. The one or more engageably-disengageable friction cams, upon movement of the engagement arm within operational limits, may disengage the at least one friction surface of the guide rail.

Additionally, or alternatively, the one or more engageably-disengageable friction cams may comprise a textured contact surface cooperating with protrusions on the friction surface of the guide rail.

Additionally, or alternatively, the carriage braking system may include one or more biasing mechanisms operationally attached to the engagement arm such that the one or more biasing mechanisms may be configured to exert a balancing force counteracting a force exerted by a load applied onto the engagement arm.

Additionally, or alternatively, a movement of the engagement arm may impart displacement of a ball-joint lever of a movement transmission mechanism of the carriage, the ball-joint lever causing an internal transmission cam to rotate, pulling a translation arm mechanism that disengages the one or more engageably-disengageable friction cams by rotation thereof. Additionally, the operational limits may be defined by one or more maximum physical distances imparted by the engagement arm to the movement transmission mechanism in one or more corresponding directions in comparison to a neutral position thereof. Additionally, or alternatively, the one or more engageably-disengageable friction cams may comprise two oppositely arranged winged-shape cams and the translation arm mechanism comprises two translation arms between the internal transmission cam and the two oppositely arranged winged-shape cams. Additionally, the two translation arms may be maintained on the internal transmission cam via a mechanical joint providing a safety gap that prevents a transfer of force when the engagement arm is moved beyond the operational limits.

Additionally, or alternatively, the carriage braking system may include a secondary immobilization mechanism, the secondary immobilization mechanism having a blocker positioned on a movable part of the carriage, where the blocker engages towards cooperating features in the guide rail when the engagement arm is moved beyond the operational limits.

In a second aspect, the technique described herein relates to a system for assisting a user to navigate a staircase. The system may include a guide rail positioned along the staircase, a carriage, a safety guard, and a brake. The carriage may be displaceable along the guide rail between a first position at a bottom of the staircase and a second position at a top of the staircase. The safety guard may be securable around the user and operably connectable to the carriage, where the carriage is configured to follow the user as the user navigates the staircase. The brake may be operably integrated to the carriage and configured to stop the carriage in place upon a loss of a balance of the user while navigating the staircase.

Additionally, the safety guard may be a guard belt positioned around the user and configured to support a weight of the user upon the loss of the balance of the user.

Alternatively, the safety guard may include a first guard bar positioned behind the user when the user faces the staircase upward, and a second guard bar positioned in front of the user when the user faces the staircase upward. The first guard bar and the second guard bar may support a weight of the user upon the loss of the balance of the user. Additionally, the first guard bar may be lifted when the carriage is positioned at the bottom of the staircase and the second guard bar may be lifted when the carriage is positioned at the top of the staircase.

Additionally, or alternatively, the guide rail may be positioned along a side wall adjacent to the staircase. Alternatively, the guide rail may be positioned along a supporting structure attached to the staircase.

Additionally, or alternatively, the carriage may be configured to move within the guide rail.

Additionally, or alternatively, the safety guard may be operationally connectable to the carriage by means of at least one link. Additionally, at least one of the at least one link may be a lever box.

Additionally, or alternatively, the brake may be a ratcheting system having a plurality of teeth embedded into the guide rail, a wheel attached to the carriage and at least one blade operatively connected to the wheel. The at least one blade may be configured to engage into the plurality of teeth to stop the carriage upon the loss of the balance of the user while navigating the staircase.

Alternatively, the brake may be the carriage braking system of the first aspect described hereinabove.

Additionally, or alternatively, the system may include a counterweight attached to the carriage, where the counterweight is configured balance the carriage when the brake is disengaged.

### BRIEF DESCRIPTION OF THE DRAWINGS

Further features and exemplary advantages of the present invention will become apparent from the following detailed description, taken in conjunction with the appended drawings, in which:

FIG. 1 is a perspective schematic view of a system for assisting a user to navigate a staircase, in accordance with an illustrative embodiment of the present invention.

FIGS. 2A, 2B and 2C, together FIG. 2, are schematic views of guide rail and carriage used in a system for assisting a user to navigate a staircase, in accordance with an illustrative embodiment of the present invention. More specifically:

FIG. 2A is a detailed perspective schematic view of the carriage shown in FIG. 2C, in accordance with an illustrative embodiment of the present invention.

FIG. 2B is a detailed front schematic view of the carriage shown in FIG. 2C, in accordance with an illustrative embodiment of the present invention.

FIG. 2C is a perspective schematic view of a guide rail and carriage used in a system for assisting a user to navigate a staircase, in accordance with an illustrative embodiment of the present invention.

FIG. 3 a perspective schematic view of a portion of a guard belt and links, in accordance with an illustrative embodiment of the present invention.

FIGS. 4A, 4B, 4C and 4D, together FIG. 4, are schematic view of a carriage with a friction cam braking system, in accordance with an illustrative embodiment of the present invention. More specifically:

FIG. 4A is a top schematic view of a carriage with friction cam braking system, in accordance with an illustrative embodiment of the present invention.

FIG. 4B is a perspective schematic view of a carriage with a friction cam braking system, in accordance with an illustrative embodiment of the present invention.

FIG. 4C is a side schematic view of a carriage with a friction cam braking system, in accordance with an illustrative embodiment of the present invention.

FIG. 4D is a front schematic view of a carriage with a friction cam braking system, in accordance with an illustrative embodiment of the present invention.

FIG. 5 is a perspective schematic view of a guide rail embedding a friction cam braking carriage, in accordance with an illustrative embodiment of the present invention.

FIGS. 6A, 6B, 6C and 6D, together FIG. 6, are schematic views of a link, in accordance with an illustrative embodiment of the present invention. More specifically:

FIG. 6A is a front schematic view of a link, in accordance with an illustrative embodiment of the present invention.

FIG. 6B is a side schematic view of a link, in accordance with an illustrative embodiment of the present invention.

FIG. 6C is a top schematic view of a link, in accordance with an illustrative embodiment of the present invention.

FIG. 6D is a perspective schematic view of a link, in accordance with an illustrative embodiment of the present invention.

FIGS. 7A, 7B, 7C and 7D, together FIG. 7, are schematic views of a safety guard, in accordance with an illustrative embodiment of the present invention. More specifically:

FIG. 7A is a front schematic view of a safety guard, in accordance with an illustrative embodiment of the present invention.

FIG. 7B is a side schematic view of a safety guard, in accordance with an illustrative embodiment of the present invention.

FIG. 7C is a perspective schematic view of a safety guard, in accordance with an illustrative embodiment of the present invention.

FIG. 7D is a top schematic view of a safety guard, in accordance with an illustrative embodiment of the present invention.

FIGS. 8A, 8B, 8C and 8D, together FIG. 8, are schematic views of a counterweight, in accordance with an illustrative embodiment of the present invention. More specifically:

FIG. 8A is a front schematic view of a counterweight, in accordance with an illustrative embodiment of the present invention.

FIG. 8B is a side schematic view of a counterweight, in accordance with an illustrative embodiment of the present invention.

FIG. 8C is a perspective schematic view of a counterweight, in accordance with an illustrative embodiment of the present invention.

FIG. 8D is a top schematic view of a counterweight, in accordance with an illustrative embodiment of the present invention.

FIG. 9 is a perspective schematic view of a system for assisting a user to navigate a staircase using a friction cam braking carriage, in accordance with an illustrative embodiment of the present invention.

### DETAILED DESCRIPTION

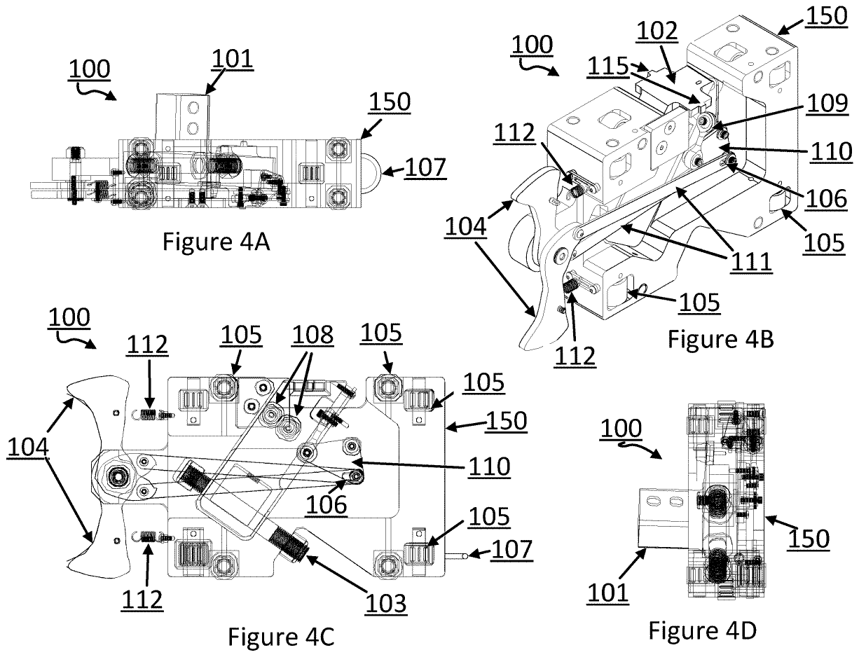

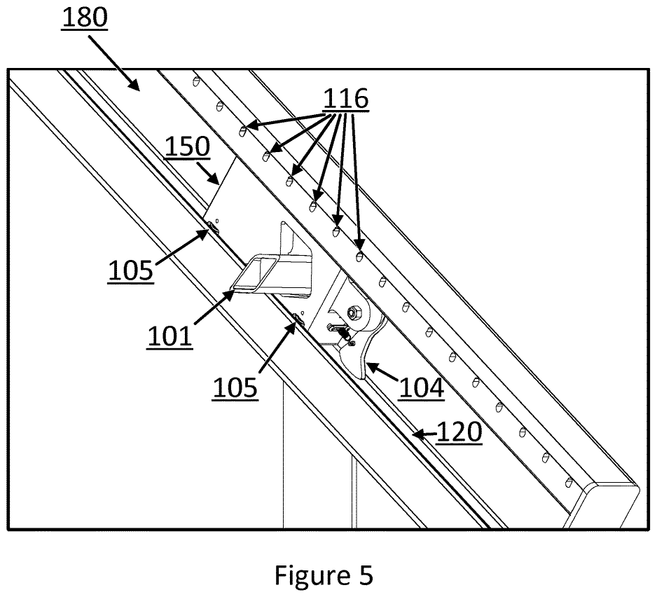

A first aspect of the teachings presented herein relates to a carriage braking system. Referring now to FIG. 4 and FIG. 5, there is shown a friction cam braking system 100 in accordance with an illustrative embodiment of the present disclosure. The carriage braking system 100 may comprise an engagement arm 102 and one or more engageably-disengageable friction cams 104. The engagement arm 102 may be operatively linked to a carriage 150 engaged to a guide rail comprising at least one friction surface 120. The engageably-disengageable friction cams 104 may, upon movement of the engagement arm 102 within operational limits, disengage the at least one friction surface 120 of the guide rail.

The friction surface 120 of the guide rail may include specialized profiles or patterns on the guide rail surface, such as grooves or ridges, to enhance friction and ensure stable carriage movement. In one embodiment, a triangular teeth like structure may be used. Other techniques may be used to create a friction surface 120, including for example using materials like rubber, polyurethane, or high-friction plastics. One friction surface 120 may be sufficient, but in one embodiment comprising two friction cams 104, two friction surfaces 120 may be used with one engaging with each friction cam 104. Other embodiments may use more than two friction surfaces 120, for example a rectangular-shaped guide rail may provide a friction surface 120 on all four internal sides of the guide rail.

The friction cams 104 may be shaped such that once the friction cam 104 engages with the friction surface 120 in a self-locking way. A self-locking design is one where once a component engages a friction surface 120, the friction force generated between them causes a positive feedback loop, leading to a rapid increase in friction and braking force. Self-locking may occur when friction between the friction cams 104 and the friction surface 120 causes the friction cams 104 to further rotate, thereby further pushing the friction cams 104 against the friction surface 120 and causing the friction force to further increase. As additional force is applied to move the carriage 150 along the guide rail, the friction cams 104 may further engage with the friction surface 120 and further increase the friction force causing the carriage 150 to brake or maintaining the carriage 150 in place. When held in place, the friction cams 104 may further benefit from a more favourable for braking static friction coefficient rather than a less favourable for braking kinetic coefficients.

In one embodiment, the friction cams 104 are engaged at rest. Once the engagement arm 102 is moved within the operation limits, the friction cams 104 disengage, thus allowing the carriage 150 to freely move along the guide rail. Upon moving the engagement arm 102 back to a resting position, the friction cams 104 re-engage with the friction surface 120.

The resting position may be configured by using one or more biasing mechanisms 108 operationally attached to the engagement arm 102. The biasing mechanisms 108 may exert a balancing force counteracting a force exerted by a load applied onto the engagement arm 102. Examples of biasing mechanisms that may be used to exert a balancing force may include counterweights, coil springs, torsion springs, flat springs, magnets, pneumatic, or hydraulic cylinders. In one embodiment, coil springs 112 may be used to exert a balancing force that pulls the friction cams 104 in an engaged configuration at rest, while torsion springs 108 may be used to balance the weight of a load attached to the engagement arm 102, such that the load may be easily lifted, and the engagement arm 102 may easily disengage the friction cams 104.

To engage or disengage the friction cams 104, the engagement arm 102 may impart displacement of a ball-joint lever 109 of a movement transmission mechanism of the carriage 150. The ball-joint lever 109 may further cause an internal transmission cam 110 to rotate. As it rotates, the internal transmission cam 110 may pull a translation arm mechanism 111 that engages or disengages the one or more friction cams 104 by rotation thereof.

The operational limits may be defined by one or more maximum physical distances imparted by the engagement arm 102 to the movement transmission mechanism in one or more corresponding directions in comparison to a neutral position thereof. In one embodiment, the engagement arm 102 is a lever with one degree of freedom around a pivot 103 at its base. The operational limits are defined as an operational arc within the degree of freedom within which the engagement arm 102 is configured to disengage the braking mechanism and allow movement of the carriage 150. When operated outside of the operational limits, in other words, when the engagement arm 102 is rotated outside of the operational arc, then the carriage braking system is configured to brake. Persons skilled in the art will readily recognize that the operational limits may be adjusted for engagement arm 102 with different degrees of freedom. For example, when the engagement arm 102 is configured to move along two degrees of freedom, the operational limits may be defined as a two-dimensional boundary within which the engagement arm 102 is expected to remain in order to disengage the braking mechanism.

A friction cam 104 may refer to a mechanical component that engages rotationally with a friction surface 120 such that it impedes the linear motion of the friction cam 104 against the friction surface 120. Some profiles may be particularly well suited for friction cam 104, including pear-shaped cams, circular cams, but persons skilled in the art will readily recognize that other cam profiles such as heart shaped or snail shaped may also be appropriate.

In one embodiment, the carriage braking system may use two oppositely arranged winged-shape cams and the translation arm mechanism 111 may use two translation arms 111 between the internal transmission cam 110 and the two oppositely arranged winged-shape cams. The winged shape may be described as skewed “S” shape with a larger upper part engaging with the friction surface 120 and a smaller lower part attaching to the translation arm 111. As the friction cams 104 rotate, the friction cams 104 may engage with the friction surface 120. In one embodiment, the friction cams 104 engage directly with the friction surface 120, meaning that the linear friction is exerted between the friction cam 104 and the friction surface 120. In other embodiments, the friction cams 104 may engage indirectly with the friction surface 120, by applying a mechanical or hydraulic force on intermediate components such as a friction pad, a brake pad or brake shoe. Persons skilled in the art will readily recognize that other intermediate components may exist, such as converting the friction cam 104 motion into an electronic signal and using this electronic signal to engage a co-configured braking system against the friction surface 120.

In one embodiment using two friction cams 104 and two translation arms 111, the two translation arms 111 may be attached to the internal transmission cam 110 via a mechanical joint providing a safety gap 106. The safety gap 106 may prevent a transfer of force when the engagement arm is moved beyond the operational limits. This may be the case when the engagement arm 102 is being moved in a direction that would further engage the friction cams 104 rather than disengage them. To avoid transferring a force that may cause damage (e.g., to the friction cams 104 and/or the surface of the guide rail) or may apply excessive pressure on the mechanical parts linking the friction cams 104 to the engagement arm 102, the safety gap 106 may allow for free motion without transferring force towards the friction cams 104.

The carriage braking system may include a secondary immobilization mechanism using a blocker 115 positioned on a movable part of the carriage 150. The blocker 115 may engage towards cooperating features 116 in the guide rail when the engagement arm 102 is moved beyond the operational limits. Example of blockers may include brake pads or brake shoes, mechanical or magnetic rail clamps, rail dogs or dogs, jaws or grippers. Using a rail dog secondary braking system, the guide rail may be configured with several holes, notches, or features. The carriage 150 may engage a protruding or extendable part 115 that may be positioned to fit in the corresponding hole 116 or feature on the guide rail. Once engaged, the rail dog may create a mechanical lock between the carriage 150 and the guide rail, preventing further movement along the guide rail. Similarly, with a rail jaw system, the carriage 150 may engage complementary shapes and features with the guide rail to prevent the carriage 150 from moving.

In one embodiment, the engagement arm 102 may be configured to move with a single degree of freedom around an axis. The engagement arm 102 may be designed with a protrusion on each side of the engagement arm 102 in the direction of its allowed movements. When the engagement arm 102 moves beyond the operational limits in one direction or the other, the protrusion engages mechanically with holes 116 perforated along the guide rail. Once one of the protrusions engages with one of the holes 116, the engagement arm 102 may be locked in place, preventing the carriage 150 from further moving along the guide rail.

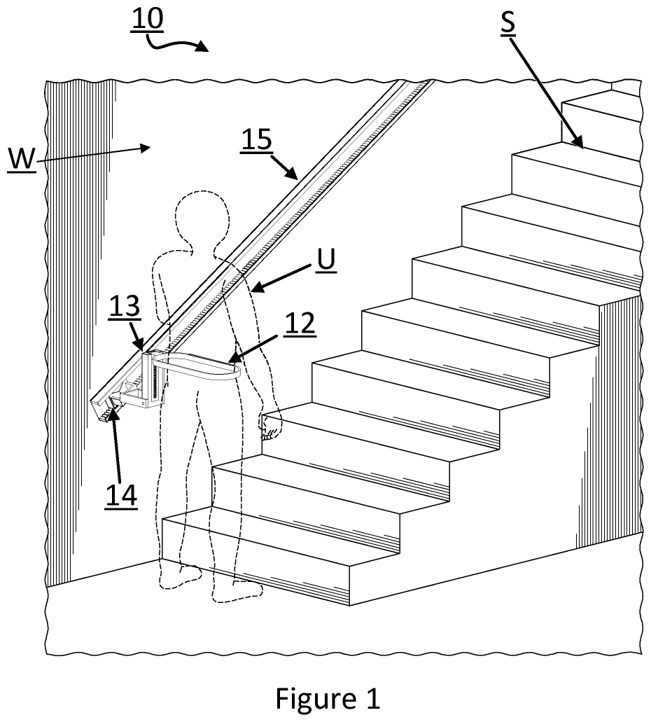

A second aspect of the teachings presented herein relates, as exemplified on FIG. 1, to a system 10 for assisting a user to navigate a staircase, in accordance with an illustrative embodiment of the present disclosure.

In the context of the present disclosure, navigating a staircase relates to the act of safely and effectively moving up or down a set of stairs or steps, typically in a controlled and deliberate manner. Navigating a staircase may involves using one's body to ascend or descend a staircase while maintaining balance and avoiding potential hazards. Navigating a staircase may also include aspects such as stepping on each individual stair, holding onto a hand rail for support, and adjusting one's pace to match the design and condition of the staircase. The action of navigating a staircase is generally performed to transition between different levels of a building or to access areas on a higher or lower floor. Navigating a staircase may require coordination, spatial awareness, and a degree of caution to ensure a safe and smooth traversal of the stairs.

A user may require assistance to navigate a staircase when at risk of losing balance due to any one of a variety of factors. Fatigue can impair coordination and stability, making it more challenging to ascend or descend stairs safely. Muscle weakness, joint problems, or balance issues may contribute to be at a higher risk of balance-related accidents on stairs. Vision problems may obscure the perception of stair depth and obstacles, increasing the likelihood of tripping. Age, particularly when accompanied by conditions like dysautonomia, may lead to disruptions in the autonomic nervous system and affect blood pressure regulation and balance. Additionally, those in recovery from an accident or dealing with a condition like diabetic neuropathy may experience a loss of sensibility in their feet, which may compromise their ability to detect and respond to changes in the staircase surface, further increasing the risk of balance-related accidents. Loss of balance may be caused by many other factors, including medication side effects, neurological issues, and vestibular disorders for example. Loss of balance, in the context of the current disclosure, may encompass various situations, including stumbling, falling, loss of consciousness, and tripping.

Persons skilled in the art will readily recognize that the system could be used in other contexts where a user U is at risk of losing balance. For example, in embodiments, if the guide rail 15 is used horizontally, this system could be used as a rehabilitation device for people who suffered from a stroke. It would allow them to walk back and forth on the floor and have a belt, loop or harness to secure them or support them to avoid a fall.

The system 10 may include a safety guard that may be secured around a user U at the bottom or at the top of a staircase S. The safety guard may provide support to the user U upon losing balance or consciousness, preventing the user from falling while navigating the staircase.

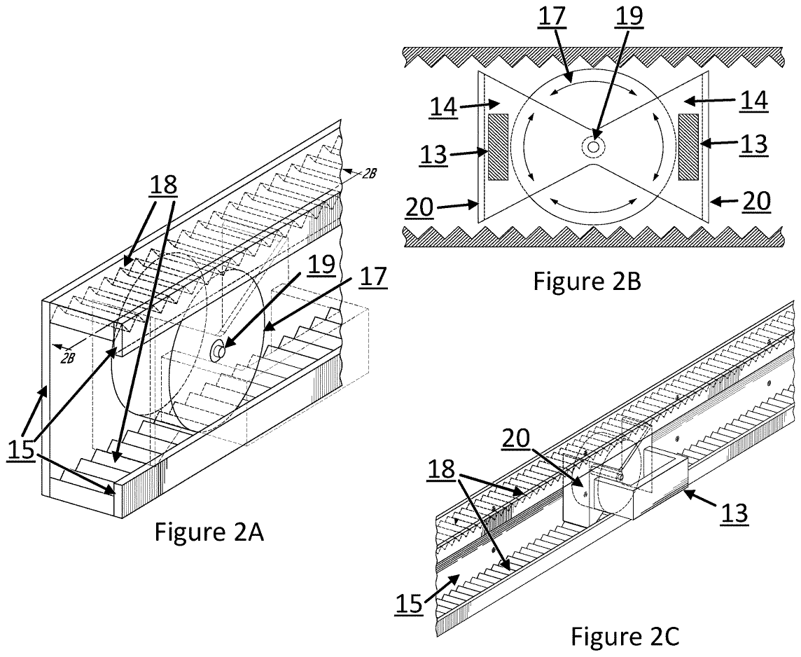

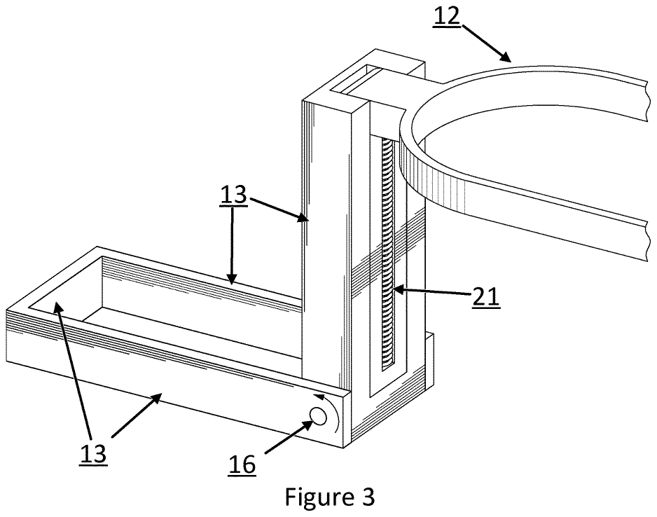

In one embodiment, the safety guard may be an adjusted rigid or soft guard belt, or guard ring and the braking mechanism may us a brake using hooking blade and/or a clutching wheel. Referring to FIG. 1 to 3, the user U may simply clip on the guard belt 12 by deploying it from the side wall W adjacent to the staircase S. Once the guard belt 12 is adjusted onto the user U, the guard belt 12 is configured to assist in guarding the user U from falling down the staircase S. When the user U loses balance, the guard belt may support the weight of the user to prevent the user U from falling.

The guard belt 12 is preferably hooked to a one or many stems or links 13 connected to a carriage 14, which may in turn be configured for rolling inside a side guide rail 15 along one of the sides of a staircase S.

The guard belt 12 may be stored at the top and/or at the bottom of the staircase S, after the user U has finished with his or her stairs displacement needs. The storage of the guard belt 12 guard belt facilitated by using a hinged system 16 located at some suitable location place along stems or links 13.

The stem or link 13 provides clearance and support to the user U who can navigate near the middle corridor of the staircase S.

Reference is now made concurrently to FIGS. 1 to 3. In one embodiment, the stem or link 13 is fixed or connected to the carriage 14 by means of one or a plurality of wheels 17 displaceable along the side guide rail 15 that is fixed to one side of the wall W of the staircase S between a first position at the bottom of the staircase S and a second position at the top of the staircase S.

The carriage 14 may brake using hooking blade and/or a clutching wheel. The carriage 14 can be stopped if the user U starts to lose balance whether the user loses balance to its front or to its rear, and this, independently if the user is climbing or descending the stairs. The carriage 14 stops because of a plurality of teeth 18 located inside the top and the bottom of the guide rail 15. The carriage 14 is configured to revolve around a support axle 19 of the wheel 17 or wheels located in the middle of the carriage 14 so that the carriage 14 hooks onto the plurality of teeth 18 fixed to the guide rail 15 via perpendicular and vertically hooking blades 20 located on both ends of the carriage 14.

One or a plurality of said wheels 17 can also be provided with a clutching wheel (not showed but within 17) that allows the carriage 14 to never accelerate down the guiderail 15. The clutching wheel allows its diameter to increase when accelerating and if so, then the clutch hooks on the plurality of teeth 18 located inside the top and the bottom of the guide rail 15.

The clutching wheel may provide a mechanical overspeed protection designed to limit the speed of the vehicle or equipment when it approaches or exceeds a preset maximum speed. A rotational speed sensing device such as a rotary encoders or tachometers, continuously monitors the speed of the rotating component. A mechanism is used to adjust the effective diameter of a wheel, for embodiments may use an expanding cone system, a threaded screw mechanism, an eccentric mechanism, hydraulic or pneumatic systems or a spring-loaded mechanism. The teeth like structure may be used as rack-and-pinion systems or a ratchet system to provide a braking effect.

A plurality of wheels 17 can also be provided with a plurality of springs under their revolving supported axle 19, which can be useful in the case the user looses conscious or looses strength in his arms or legs, as the user will not fall down the stairs since the hooking blades 20 located on each ends of the carriage 14 will then be stopped by a plurality of the teeth 18 fixed to the guide rail 15.

Along the stem or link 13 supporting and hooked to the safety guard 12, a plurality of springs 21 or a telescoping vertical sliding guide (not shown) equipped with a plurality of springs, may allow the user to be suspended if the user looses conscious or looses strength in his arms or legs. The user U will then not be falling down the stairs since the carriage 14 may then be stopped by a plurality of teeth 18 fixed to the guide rail 15 via perpendicular and vertically hooking blades or wings 20 located on both ends of the carriage 14.

In embodiments, the carriage 14 can also be motorized to slightly help the user to climb the stairs.

In embodiments, the guard belt 12 and the hinged stem 13 can be modified by equivalent devices achieving similar functions as persons skilled in the art will understand. Also, the set of wheels 17 on carriage 14 may be changed or replaced by a sliding carriage, although it would not be as efficient because of an added resistance for the user.

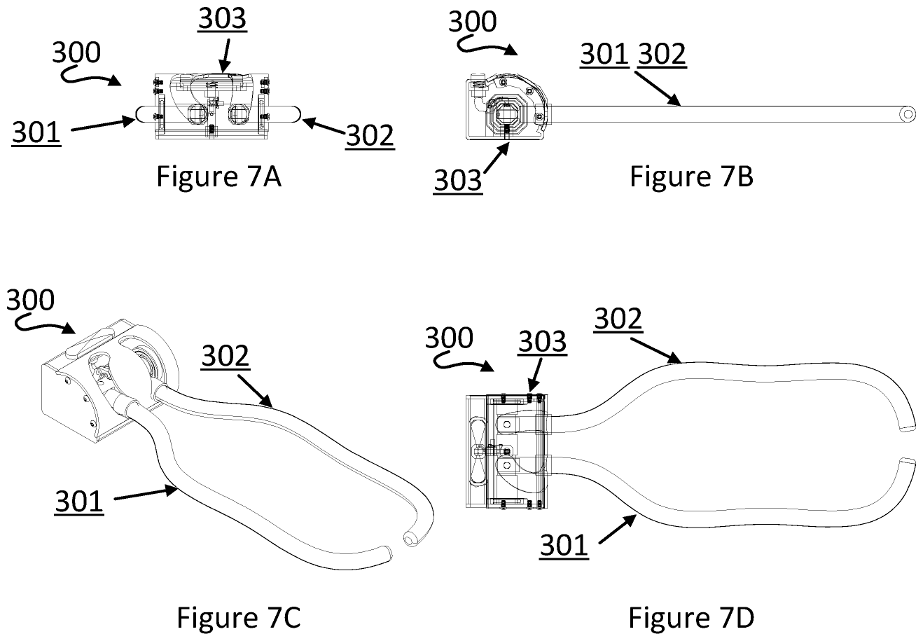

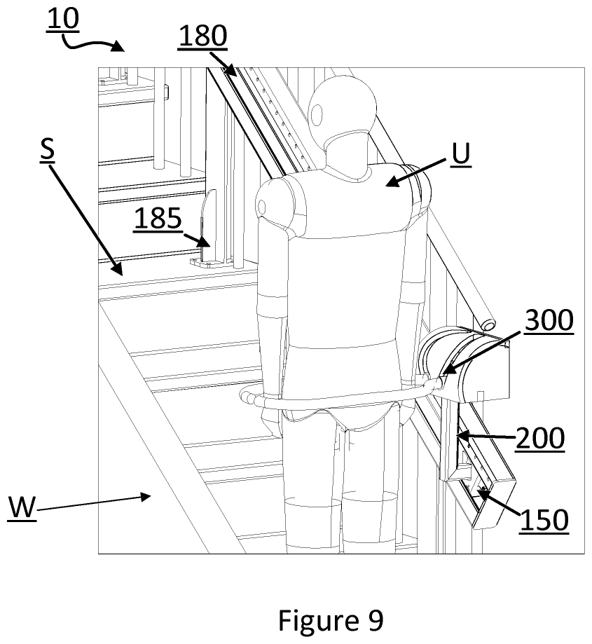

In another embodiment, the system for assisting a user to navigate a staircase may use guard bars for the safety guards and a friction cam braking carriage. Referring now concurrently to FIG. 7 and FIG. 9, there is shown a safety guard comprising guard bars 300. In one embodiment, guard bars 300 may be used as a safety guard. Two solid bars 301 and 302 may curve around the user and be attached to a mounting 303 using hinges, pivots, or a central point that allows rotation. The solid bars 301 and 302 may be cushioned for comfort. The tip of the two solid bars 301 and 302 may or may not touch. The user U may be fully enclosed or partially enclosed between the two guard bars. The guard bars 300 may be configured to support the weight of the user upon the loss of the balance of the user U.

In one embodiment, a first guard bar 302 may be positioned behind the user U when the user faces the staircase S upward while a second guard bar 301 may be positioned in front of the user U when the user faces the staircase S upward. A mounting 303 may allow the first guard bar 302 and the second guard bar 301 to be raised or lifted independently. The first guard bar 302 may be lifted when the carriage is positioned at the bottom of the staircase S and the second guard 301 bar may be lifted when the carriage is positioned at the top of the staircase S. When the user U approaches the staircase S from the bottom, the user U may proceed to lift the first guard bar 302 and move between the two guard bars 301 and 302 before lowering the first guard bar 302. Upon reaching the top of the staircase, the user U may lift the second guard bar 301 and moves away from the staircase. When the user U approaches the staircase S from above, the user U proceeds to lift the second guard bar 301 and moves between the two guard bars 301 and 302 before lowers the second guard bar 301. Upon reaching the bottom of the staircase, the user U may lift the first guard bar 302 and moves away from the staircase. In other embodiments, the first guard bar 302 and the second guard bar 301 may swing horizontally instead of vertically.

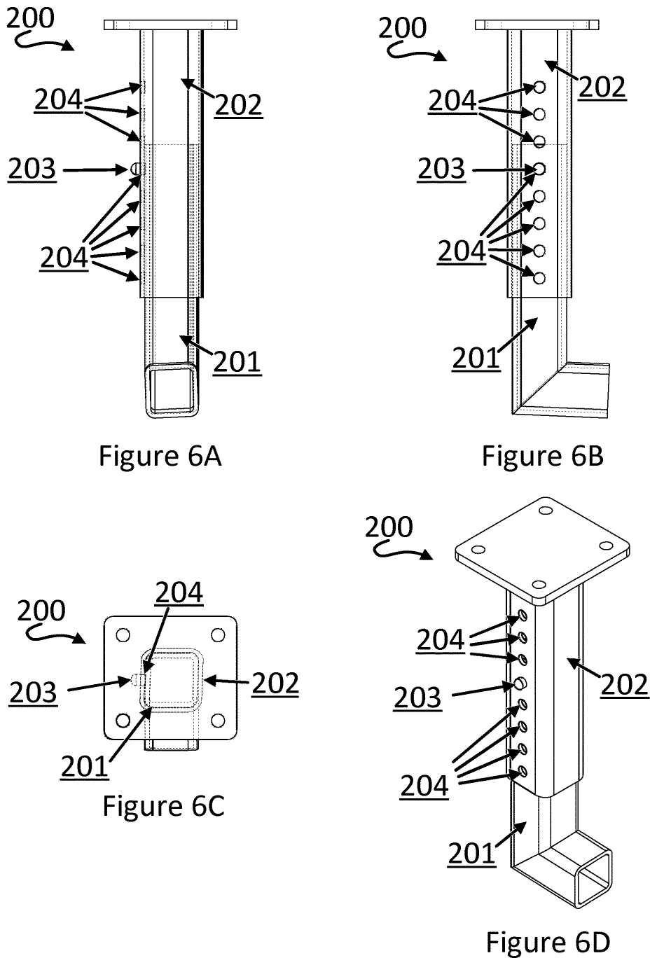

Reference is now made concurrently to FIG. 4 to 9. The guard bars 300 are preferably hooked to a lever box such as a telescoping arm 200 connected to the link anchor 101 of a carriage 150, which is in turn configured for rolling inside a side guide rail 180 along one of the sides of a staircase S. The telescoping arm 200 may consisting of an outer section 202 and an inner section 201. The length of the telescoping arm 200 may be adjusted by sliding the inner section 201 in or out of the outer section 202 to the desired position. Various locking mechanism exist, for example, both sections may have a series of locking holes 204 aligned along their length. These locking holes 204 may be evenly spaced to allow for different length settings. A locking pin is then inserted into two aligned locking holes 204, in some embodiments across one side of the telescoping arm 200 and in other embodiments across two opposite sides of the telescoping arm 200. In another embodiment, a spring-loaded pin 203 is attached to the inner section 201 and a series of locking holes 204 are evenly spaces to allow for different length settings. The spring-loaded pin 203 may be designed to be spring-loaded, meaning it can be pushed when sliding, and a spring mechanism inside the spring-loaded pin 203 provides resistance and pushes it back out when not actively compressed. Upon adjusting the desired telescoping arm 200 length, the spring-loaded pin 203 is allowed to extend through one of the locking holes 204 of the outer section 202, thereby locking the outer section 202 in place.

Rolling inside a side guide rail 180 may refer to a mechanical design where the carriage 150 responsible for carrying a load and facilitating motion, may be positioned inside a specially designed guide rail 180 The carriage 150 may fit snugly within a groove or channel in the guide rail 180, allowing it to move along the guide rail's length. The carriage 150 and guide rail 180 may be manufactured with close tolerances to ensure a precise fit, which may provide improved stability, reduced vibrations, and increased load capacity. The carriage 150 may be equipped with rollers, ball bearings 105, or other mechanisms that may allow it to move smoothly within the guide rail while carrying a payload.

The guide rail 180 may be installed along the wall W on either side of staircase S. The guide rail 180 may also be attached to a supporting structure 180 attached to the staircase S. Some examples of supporting structures include support columns, posts including newel posts or balusters and glass panels.

The carriage 150 may brake using the friction cam 104 carriage braking system 100 described hereinabove. In use, the carriage 100 may be stopped if the user U starts to lose balance whether the user U loses balance to its front or to its rear, and this, independently if the user U is climbing or descending the stairs. The carriage 150 stops because of a friction cam 104 braking system 100 that is activated by the whole system's weight or because the user U pull the whole system up. When the link anchor 101 is pulled vertically down or vertically up, the link anchor 101 rotates. When the link anchor 101 is pulled vertically up, the lever 102 activates the friction cams 104 horizontally so the two friction cams 104 are opening to squeeze tight into the guide rail 180. A plurality of teeth (not shown) located inside the top and the bottom of the guide rail 180 may also be used as a second protection to stop the carriage 150 or when the user U is removing up the bars at the top or the bottom of the stairs to leave it.

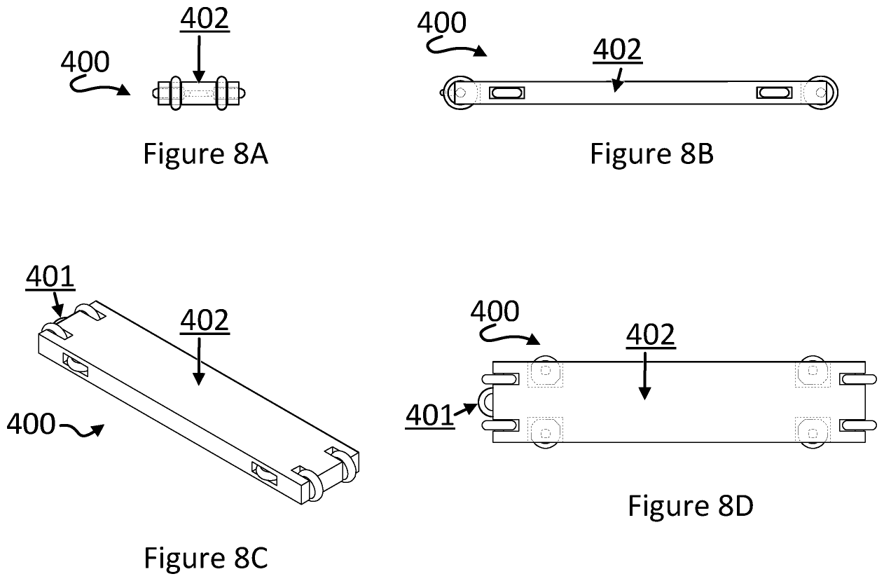

Referring now concurrently to FIGS. 4 and 8. In embodiments, the carriage 150 may also be motorized or balanced using a counterweight or pulley-weighed cable systems installed at the top of the stairs to slightly help the user to climb the stairs. The pulley-weighed cable systems may be achieved by attaching a cable (not shown) from the hook 107 of the carriage 100 to a hook of a 401 of a counterweight cartridge 400 over a pulley (not shown) at the top of a staircase. The counterweight cartridge 400 may be a self-contained, compact unit located within the guide rail structure and may provide a balancing force that offsets the weight of the carriage 100, including any payload permanently attached thereto. The counterweight cartridge 400 may consist of a weight 402 or a stack of weights, often made of materials like cast iron, concrete, or other dense materials. The weight 402 may be calibrated to balance the weight of the carriage 100. As the carriage 100 moves upward, the counterweight cartridge 400 moves downward, and as the carriage 100 moves downward, the counterweight cartridge 400 moves upward, thereby creating a counterbalancing effect. This arrangement may reduce the power required to move the carriage 100.

Referring to FIGS. 1 and 9, an advantage of the system 10 is that it provides a safety guard such as a guard belt 12 or a guard bar 300 to the user U that is moveable and follows the user climbing or descending any stairs. Contrary to conventional hand rail ramps or existing assisted moveable handle bars, the present system 10 will provide safety by augmenting security of the user U such that, if the user U looses conscious, or looses balance or looses strength in his arms or legs, the user U the guard belt 12 or guard bar 300 will be engaged to prevent the user U from falling down the stairs and suffering serious injury or death.

The scope of the claims should not be limited by the preferred embodiments set forth in the examples but should be given the broadest interpretation consistent with the description as a whole.

1. A system (10) for assisting a user (U) to navigate a staircase (S), the system (10) comprising:
a guide rail (180) positioned along the staircase(S) and comprising at least one friction surface (120);
a carriage (150) displaceable along the guide rail (180) between a first position at a bottom of the staircase(S) and a second position at a top of the staircase (S);
a braking system (100), comprising:
an engagement arm (102) operatively linked to the carriage (150) and comprising at least one link (101); and
one or more engageably-disengageable friction cams (104) configured for self-locking with the at least one friction surface (120) using static friction;
a safety guard (300) securable around the user (U) and operably connectable to the at least one link (101) of the engagement arm (102), the safety guard (300) comprising:
a first guard bar (301) positioned behind the user (U) when the user (U) faces the staircase(S) upward; and
a second guard bar (302) positioned in front of the user (U) when the user (U) faces the staircase(S) upward;
wherein the carriage (150) is configured to follow the user (U) as the user (U) navigates the staircase (S);
wherein the first guard bar (301) and the second guard bar (302) are configured to support a weight of the user (U) upon a loss of balance of the user (U); and
wherein the braking system (100) is operably integrated to the carriage (150) and configured to:
engage the one or more engageably-disengageable friction cams (104) with the at least one friction surface (120) of the guide rail (180) when the safety guard (300) is at rest; and
disengage the one or more engageably-disengageable friction cams (104) from the at least one friction surface (120) of the guide rail (180) when at least one of the first guard bar (301) and the second guard bar (302) is lifted by the user (U);
thereby stopping the carriage (150) in place upon the loss of the balance of the user (U) while navigating the staircase(S).

2. The system of claim 1, wherein the first guard bar (301) and the second guard bar (302) connect and surround the user (U).

3. The system of claim wherein the first guard bar (301) is liftable when the carriage is positioned at the bottom of the staircase(S) and the second guard bar (302) is liftable when the carriage is positioned at the top of the staircase(S).

4. The system of claim 1, wherein the guide rail (180) is positioned along a side wall (W) adjacent to the staircase(S).

5. The system of claim 1, wherein the guide rail (180) is positioned along a supporting structure attached to the staircase(S).

6. The system of claim 1, wherein the carriage (150) is configured to move within the guide rail (180).

7. The system of claim 1, wherein at least one of the at least one link (101) is a lever box.

8. The system of claim 1, further comprising one or more biasing mechanisms (108) operationally attached to the engagement arm (102), wherein the one or more biasing mechanisms (108) is configured to exert a balancing force counteracting a force exerted by a load applied onto the engagement arm (102).

9. The system of claim 1, wherein movement of the engagement arm (102) imparts displacement of a ball-joint lever (109) of a movement transmission mechanism of the carriage (150), the ball-joint lever (109) causing an internal transmission cam (110) to rotate, pulling a translation arm mechanism (111) that disengages the one or more engageably-disengageable friction cams (104) by rotation thereof.

10. The system of claim 9, wherein the one or more engageably-disengageable friction cams (104) comprise two oppositely arranged winged-shape cams and the translation arm mechanism (111) comprises two translation arms (111) between the internal transmission cam (110) and the two oppositely arranged winged-shape cams.

11. The system of claim 10, wherein the two translation arms (111) are maintained on the internal transmission cam (110) via a mechanical joint providing a safety gap (106) that prevents a transfer of force when the engagement arm (102) is moved beyond a maximum distance from a neutral position thereof.

12. The system of claim 1, further comprising a secondary immobilization mechanism, the secondary immobilization mechanism comprising a blocker (115) positioned on a movable part of the carriage (150), wherein the blocker (115) engages towards cooperating features (116) in the guide rail (180) when the engagement arm (102) is moved beyond a maximum distance from a neutral position thereof.

13. The system of claim 1, further comprising a counterweight attached to the carriage, wherein the counterweight is configured to balance the carriage when the braking system (100) is disengaged.

14. A carriage braking system for assisting with staircase navigation comprising:
an engagement arm (102) operatively linked to a carriage (150) engaged to a guide rail (180) comprising at least one friction surface (120);
one or more engageably-disengageable friction cams (104) that, upon movement of the engagement arm (102) within operational limits, disengage the at least one friction surface (120) of the guide rail (180);
one or more biasing mechanisms (108) operationally attached to the engagement arm (102); and
a secondary immobilization mechanism, the secondary immobilization mechanism comprising a blocker (115) positioned on a movable part of the carriage (150), wherein the blocker (115) engages towards cooperating features (116) in the guide rail (180) when the engagement arm (102) is moved beyond the operational limits;
wherein:
the one or more biasing mechanisms (108) being configured to exert a balancing force counteracting a force exerted by a load applied onto the engagement arm (102);
a movement of the engagement arm (102) imparts displacement of a ball-joint lever (109) of a movement transmission mechanism of the carriage (150), the ball-joint lever (109) causing an internal transmission cam (110) to rotate, pulling a translation arm mechanism (111) that disengages the one or more engageably-disengageable friction cams (104) by rotation thereof;
the operational limits are defined by one or more maximum physical distances imparted by the engagement arm (102) to the movement transmission mechanism in one or more corresponding directions in comparison to a neutral position thereof;
the one or more engageably-disengageable friction cams (104) comprise two oppositely arranged winged-shape cams and the translation arm mechanism (111) comprises two translation arms (111) between the internal transmission cam (110) and the two oppositely arranged winged-shape cams; and
the two translation arms (111) are maintained on the internal transmission cam (110) via a mechanical joint providing a safety gap (106) that prevents a transfer of force when the engagement arm (102) is moved beyond the operational limits.
